(19) United States
(12) Patent Application Publication
(10) Pub. No.: US 2007/0264473 A1
(43) Pub. Date: Nov. 15, 2007

(54) Air cushioning wrapping bag

(76) Inventor: Chian Hua Liao, Sindan City (TW)

Correspondence Address: RABIN & Berdo, PC, 1101 14TH STREET, NW, SUITE 500, WASHINGTON, DC, 20005, US

(21) Appl. No.: 11/430,953

(22) Filed: May 10, 2006

(51) Int. Cl. B32B 3/00

(52) U.S. Cl. 428/166; 428/188

(57) ABSTRACT

An air cushioning wrapping bag for wrapping a product in any shape or size is disclosed. A strip of main air tubes includes a first folding unit, a second folding unit, and a connecting unit. The connecting unit connects with the first folding unit and second folding unit. Two strips of peripheral air tubes connect to two sides of the air tubes strip. The tube diameter of the peripheral air tube is larger than the tube diameter of the air tubes strip so that when the first folding unit, the second folding unit, and their respective peripheral air tubes strips fold, a containing space for housing the product and an air cushioning layer surrounding the containing space for protecting the product are formed.

### BACKGROUND OF THE INVENTION

1. Field of Invention

The present invention relates to a wrapping bag, more particularly to an air cushioning wrapping bag in strip form that may also be extendible to any length or width to wrap products in any size or shape and effectively prevent damages during the shipment.

2. Description of Related Art

Conventional wrapping or packaging materials generally include Bubble-Wrap, Styrofoam, or other materials for wrapping products to prevent damages that might occur during the shipment. Bubble-Wrap, for example, consists of two layers of thin plastic material formed with random bubbles between the layers and filled with air at the time of manufacture. The Bubble-Wrap may wrap either of products in any shape or size. However, to avoid damages that might occur to wrapped products during the shipment, more Bubble-Wraps for protection to these products is required. For another example, Styrofoam is a light, resilient Polystyrene plastic material and widely used for product wrapping. To wrap products in different shape or size, Styrofoam may be made to conform to the shape or size of the products. But inflexible, also fixed, and consolidated characters of the Styrofoam make it inconvenient for manufacture, unable for the re-use, and even difficult on the compliance for environmental protection.

Referring to FIGS. 1, and 2 a conventional wrapping bag is described. By sealing the heat seal lines 12, the miscible glues 15 between air tubes strips 13, 14 are sealed to form a wrapping bag 1. After all the air tubes are filled with air, a containing space 10 is formed. On one side of the wrapping bag 1 provides an opening 11 in which a product may be put into the containing space 10. This wrapping bag 1 requires precise calculation on the distance between the air tubes 16 and the location of heat seal lines 12. If the location of heat seal lines 12 is too close to the air tubes 16, the air tubes 16 on the edge of air tubes strips 13, 14 may encounter and therefore reduce the containing space 10. In contrast, if the location of heat seal lines 12 is distant from the air tubes 16, the containing space 10 would leave an extra space and result in damages to the products by the collisions during the shipment.

Taiwan patent (Patent No. M285552) for “An air packing bag having reinforced sides with regulating pressure” discloses an air packing bag having two pressure adjustment devices on both sides of the air packing bag to prevent the collisions. The pressure adjustment device includes a number of collision preventive air chambers, and air adjustment chambers that cooperate with the collision preventive air chambers. When the collision occurs, the collision preventive chambers transfer air to the air adjustment chambers so that the breaking on the collision preventive air chambers due to the shocks is prevented.

Taiwan patent (Patent No. M263325) for “An air packing bag can adjust pressure” discloses an air packing bag having pressure adjustment mechanism. The air packing bag includes a plurality of main air tubes, and a plurality of supportive air tubes between the each and every of main air tubes. The diameter of main air tubes is larger than that of the pressure adjustment air tubes. Between each main air tube and supportive air tube, a heat seal line is disposed. An air channel on the heat seal line provides air flow between the main air tube and the supportive air tube. This arrangement defines an air tube group. Each of the groups is isolated from each other by heat seal lines. In other words, the air flow between groups is impossible. Therefore, when either the main air tube or the supportive air tube of one group leaks, the other groups may still function.

The above two patents merely disclose packing bags with pressure adjustment mechanism. By providing air flow between air tubes and supportive air tubes, or between collision preventive air chambers and air adjustment chambers, the breaking on the chambers or air tubes may be prevented. However, when either one of the chambers, or either one of the air tubes, breaks and then leaks, their counterpart also runs out of air. Also, these bags require pre-determining their sizes on the designing step for specific products. It may not be re-used for other products in different size or shape again. Since these bags are designed to pack specific size or shape of products, the rectangular-shape opening as entry for those specific products might tear. After these bags packed with products have been put into a box, their cambered surface on the front of the bags makes them unlikely to ideally conform to the box. Collisions between the inner walls of the box and these bags during the shipment inevitably occur.

### SUMMARY OF THE INVENTION

An objective of the invention is to provide an air cushioning wrapping bag in strip form that may warp products in any shape or size.

Another objective of the invention is to provide an air cushioning wrapping bag that may maintain its functionality even one or more of its air tubes leak.

Another objective of the invention is to provide an air cushioning wrapping bag that may effectively prevent damages during the shipment.

To achieve the above objectives, in one aspect, the invention provides an air cushioning wrapping bag including a strip of main air tubes and a pair of peripheral air tubes strips. The main air tubes strip includes multiple main air tubes in a row arrangement that each main tube is separate from and parallel to each other. The main air tubes strip is divided into three sections, an upper main section, a lower main section, and a connecting main section. The connecting main section disposes between and connects with the upper and lower main sections. Multiple folding points are formed along the two sides of the connecting main section and between the upper and lower main sections. The two peripheral air tubes strips respectively connect with both sides of the main air tubes strip. Each of the peripheral air tubes strips includes a connecting peripheral section, an upper peripheral section and a lower peripheral section. The upper peripheral section and the lower peripheral section connect with the connecting peripheral section. In this embodiment, each of the main air tubes for both of the upper and the lower main sections contains equal length.

In another aspect, the air cushioning wrapping bag includes a strip of main air tubes and a pair of peripheral air tubes strips. The main air tubes strip includes multiple main air tubes in a row arrangement. The main air tubes strip includes five sections, two upper main section, a lower main section, and two connecting main section. Both of the connecting main sections dispose between and connect with the upper and the lower main sections. Multiple folding points are formed along the two sides of the connecting main section and between the upper and lower main sections. In this embodiment, each of the main air tubes' length of the lower main section is longer than the length for each of the main air tubes of the upper main sections. The two peripheral air tubes strips respectively connect with both sides of the main air tubes strip. Each of the peripheral air tubes strips includes two connecting peripheral sections, two upper peripheral sections, and a lower peripheral section. The connecting peripheral sections connect one ends with the lower peripheral section and the opposite ends with the upper peripheral sections.

In operation, the upper and lower main sections define their respective first folding unit and second folding unit. The peripheral air tube's diameter of the peripheral air tubes strips is larger than that of its respective main air tubes. When folding the first folding unit, the second folding unit, and their respective peripheral air tubes strips, a containing space for housing a product, such as an electronic device, and an air cushioning layer surrounding the containing space for protection are formed. The peripheral air tubes on the edges of the electronic device holds and firmly fastens the device in a manner that the mobility of the device is unlikely occurred. The device is therefore in a secure position. Since the electronic device is fastened in a secure position leaving no more space for possible collision between the peripheral air tubes and the electronic device, the damages to the device is preventable. Furthermore, when the wrapped electronic device is put into a box, the peripheral air tubes are against the inner walls of the box as well as the multiple main air tubes for the air cushioning, the damages by collision due to improper handlings or during the shipment may effectively prevent.

In another aspect, an air cushioning wrapping bag includes a strip of main air tubes and a pair of peripheral air tubes strips. The main air tubes strip includes multiple main air tubes in a row arrangement. The strip of main air tubes is divided into seven sections, four upper main sections, a lower main section, and two connecting main section. The lower main section which disposes in the middle of the main air tubes trip with its both sides perpendicular to the main air tubes connects with the connecting main sections. And the other sides of the connecting sections, which are not connected with the lower main section, connect with two upper main sections. These two upper main sections are arranged by connecting one to the other in sequence. Then, two peripheral air tubes strips connect with two sides of main air tubes strip. Each of the peripheral tubes strip includes a lower peripheral section, two connecting peripheral section connecting with two ends of the lower peripheral section, and two upper peripheral sections that is arranged in sequence connecting with the other end of the connecting peripheral section. These peripheral sections are parallel and with equal lengths to their respective main air tubes sections. The connecting folding units connect one side with the first folding units and the other side with the second folding unit. The peripheral air tubes of the peripheral air tubes strips contain larger tube diameter than that of all the main air tubes. When folding the first folding units, the second folding unit, and their respective peripheral sections, a containing space for which an electronic device may be housed in and an air cushioning layer surrounding the containing space for protection are formed. Multiple folding points are formed on and along each side of all the sections during the heat-sealing operation.

In another aspect, a modification of an air cushioning wrapping bag is described. A wrapping bag includes a strip of main air tubes and a pair of peripheral air tubes strips. The main air tubes strip includes multiple main air tubes in a row arrangement. The strip of main air tubes is divided into two sections, an upper main section and a lower main section. Multiple folding points are formed during the heat-sealing operation between the two main sections. Each of the two peripheral air tubes strips respectively connects with one side of the main air tubes strip. Further, each of the peripheral air tubes strips includes an upper and a lower peripheral section. The upper and lower main sections define their respective first folding unit and second folding unit. The folding points arrangement in the middle of the first folding unit and the second folding unit may allow them to fold.

Among the advantages of the invention are the following. The invention provides various configurations on the first folding unit and second folding unit of the wrapping bag in accordance with the shapes and sizes of the products. The strip form design for the wrapping bag may wrap any shape and size of products such as sensitive, sophisticated, and fragile products that require the prevention of damages during the shipment. To meet and warp any size or shape of products, the wrapping bag may be tailored by adding more or reducing some of the strips. Each of the main tubes and peripheral air tubes is a separate entity. Even under certain circumstance, one or more of the tubes may leak air, the remainder still functions. The peripheral air tubes on the edges of the electronic device holds and firmly fastens the device in a manner that the mobility of the device is unlikely occurred. The device is therefore in a secure position. Because the edges of the peripheral air tubes are against the inner walls of the box, the wrapped product may be fastened in a secure position. With the multiple air tubes providing the air cushioning to the products, inevitable damages due to the improper handling during the shipment may effectively prevent.

### BRIEF DESCRIPTION OF THE DRAWINGS

FIG. 1 is a diagrammatic perspective view of a conventional wrapping bag.

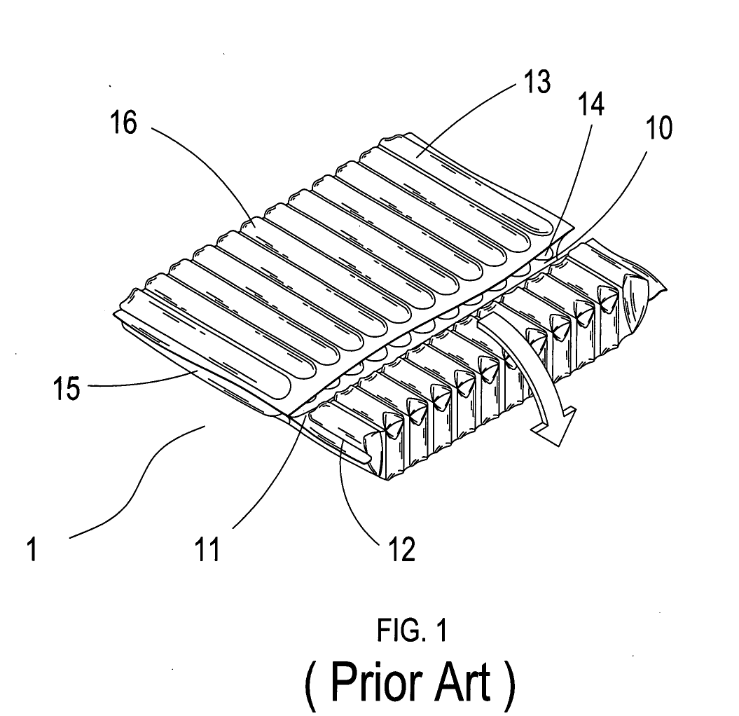

FIG. 2 is a diagrammatic cross-sectional view of a conventional wrapping bag.

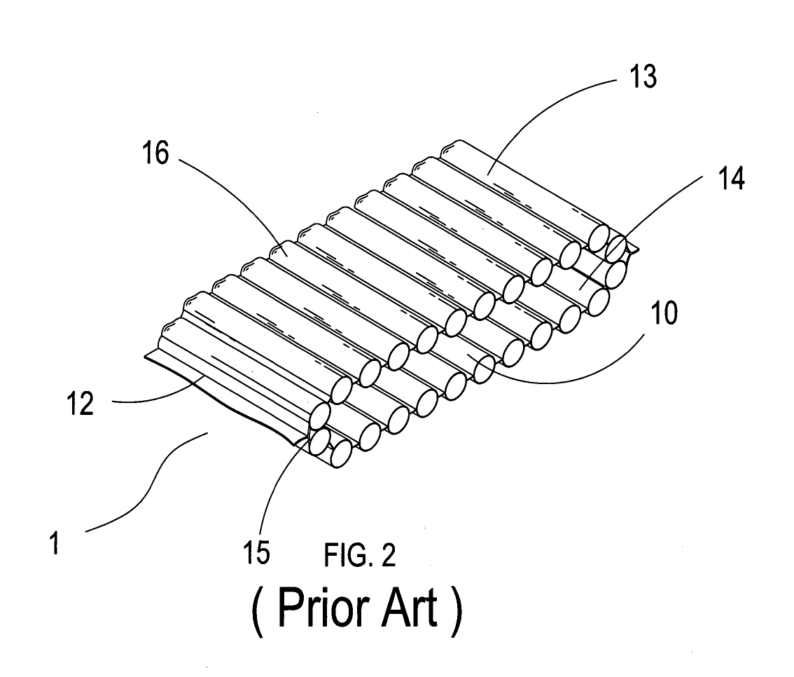

FIG. 3 is a diagrammatic perspective view of the embodiment of the invention.

FIG. 4 is a diagrammatic cross-sectional view of the embodiment of the invention.

FIG. 5 is a diagrammatic perspective view of another embodiment of the invention.

FIG. 6 is a diagrammatic perspective view illustrating the air cushioning wrapping bag of the invention that wraps an electronic device.

FIG. 7 is a diagrammatic perspective view illustrating the air cushioning wrapping bag of the invention that has wrapped an electronic device and put into a box.

FIG. 8 is a diagrammatic cross-sectional view illustrating the air cushioning wrapping bag of the invention that has wrapped an electronic device and put into a box.

FIG. 9 is a diagrammatic perspective view of another embodiment of the invention having multiple connecting main sections and upper sections arrangement.

FIG. 10 is a diagrammatic perspective view of a modification of the invention.

FIG. 11 is a diagrammatic perspective view of a modification of the invention illustrating that two folding units and their respective peripheral air tubes strips are folded.

### DESCRIPTION OF PREFERRED EMBODIMENT

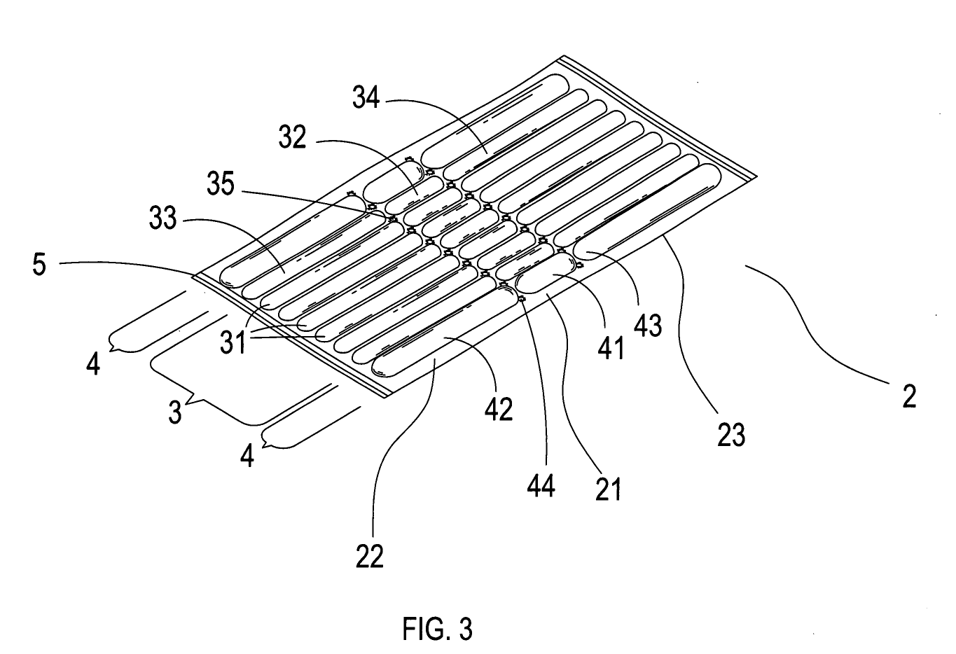

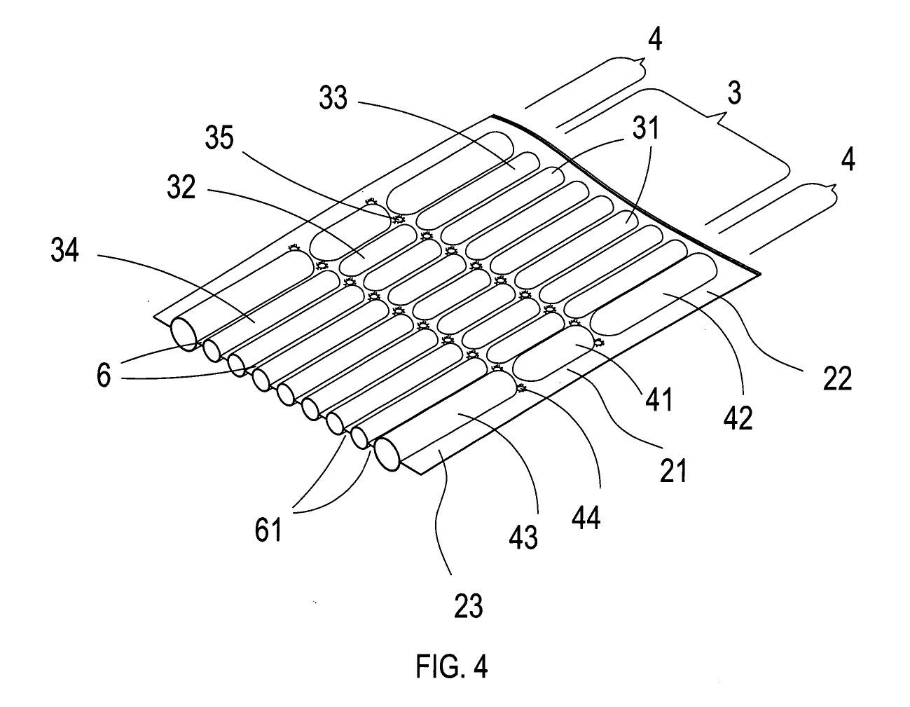

FIGS. 3 and 4 depict the perspective views of an embodiment of the invention. An air cushioning wrapping bag 2 includes a strip of main air tubes 3 and a pair of peripheral air tubes strips 4. The main air tubes strip 3 includes multiple main air tubes 31 structured in a row arrangement that each of the main air tubes 31 is separate from and parallel to each other. The main air tubes strip 3 is divided into three sections, an upper main section 33, a lower main section 34, and a connecting main section 32. The connecting main section 32 disposes between and connects with the upper and lower main sections 33, 34. Multiple folding points 35 are formed during the heat-sealing operation along the two sides of the connecting main section 32 and between the upper and lower main sections 33, 34. Then, the two peripheral air tubes strips 4 respectively connect with both sides of the main air tubes strip 3. Each of the peripheral air tubes strips 4 includes a connecting peripheral section 41, and an upper peripheral section 42 and a lower peripheral section 43. The upper peripheral section 42 and the lower peripheral section 42 connect with the connecting peripheral section 41. These peripheral sections 41, 42, 43 are parallel and with equal lengths to their respective main air tubes sections, the connecting main section 32, the upper main section 33, and the lower main section 34. In this embodiment, each of the main air tubes 31 for both of the upper and the lower main sections 33, 34 contains equal length. The wrapping bag 2 is formed by sealing the heat seal lines 5 with a heat press device.

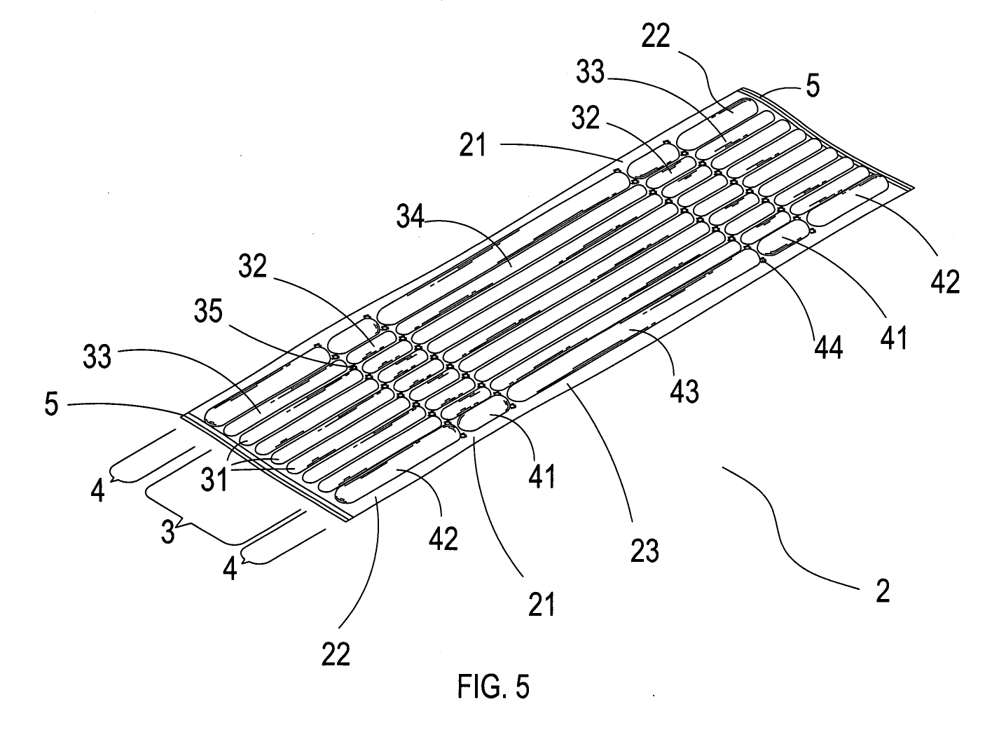

FIG. 5 depicts a perspective view of another embodiment of the invention. An air cushioning wrapping bag 2 includes a strip of main air tubes 3 and a pair of peripheral air tubes 4 strips. The main air tubes strip 3 includes multiple main air tubes 31 structured in a row arrangement that each main tube 31 is separate from and parallel to each other. The main air tubes strip 3 includes five sections, two upper main section 33, a lower main section 34, and two connecting main sections 32. Both of the connecting main sections 32 dispose between and connect with the upper and the lower main sections 33, 34. Multiple folding points 35 are formed during the heat-sealing operation along the two sides of the connecting main section 32 and between the upper and lower main sections 33, 34. In this embodiment, each of the main air tubes' length of the lower main section 34 is longer than the length for each of the main air tubes of the upper main sections 33. Then, the two peripheral air tubes strips 4 respectively connect with both sides of the main air tubes strip 3. Each of the peripheral air tubes strips 4 includes two connecting peripheral sections 41, two upper peripheral sections 42, and a lower peripheral section 43. The connecting peripheral sections 41 connect one ends with the lower peripheral section and the opposite ends with the upper peripheral sections 42. These peripheral sections 41, 42, and 43 are parallel and with equal lengths to their respective main air tubes sections, the connecting main section 32, the upper main section 33, and the lower main section 34. The wrapping bag 2 is formed by sealing the heat seal lines 5 with a heat press device.

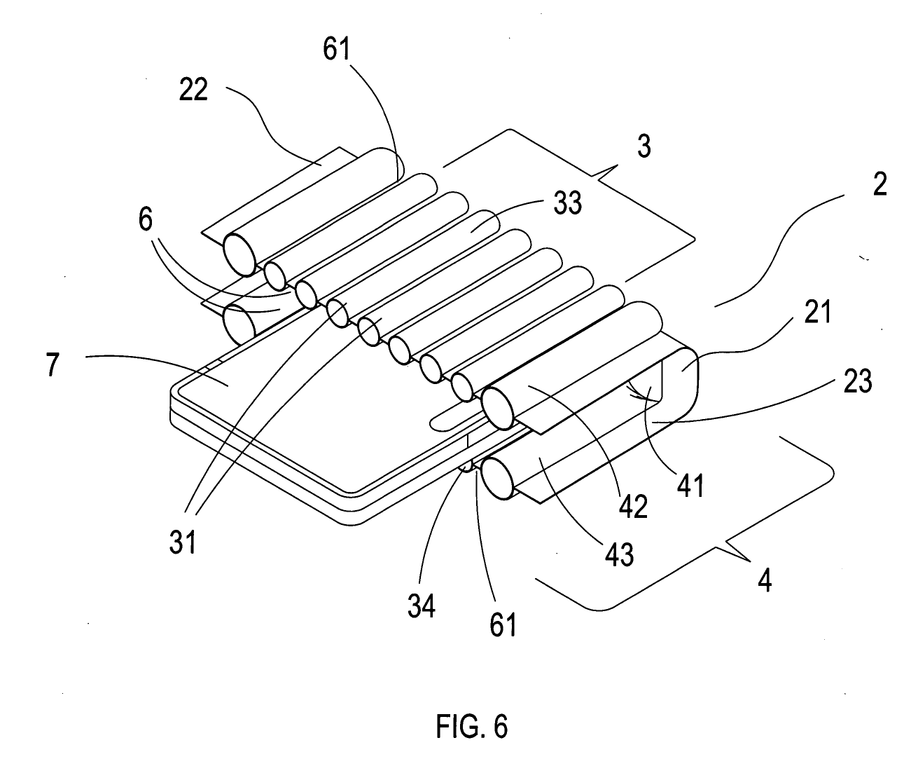

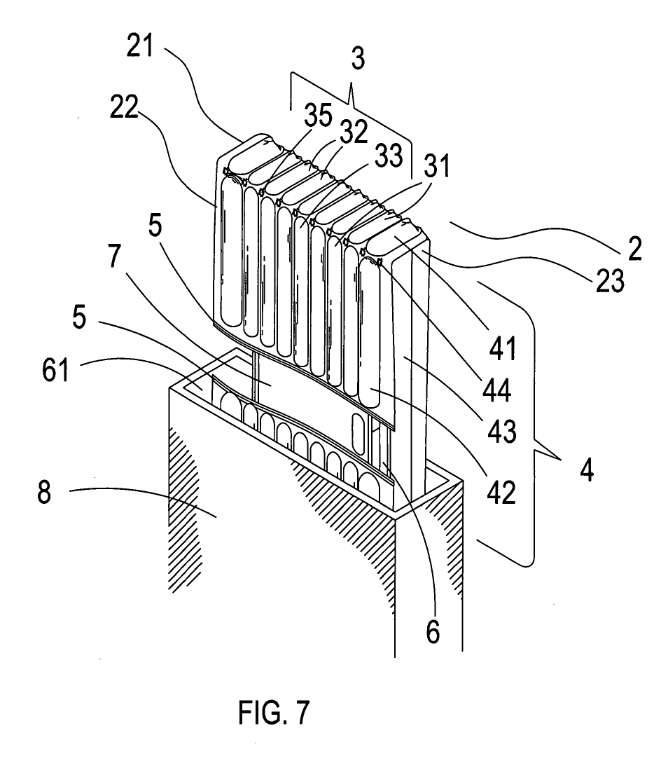

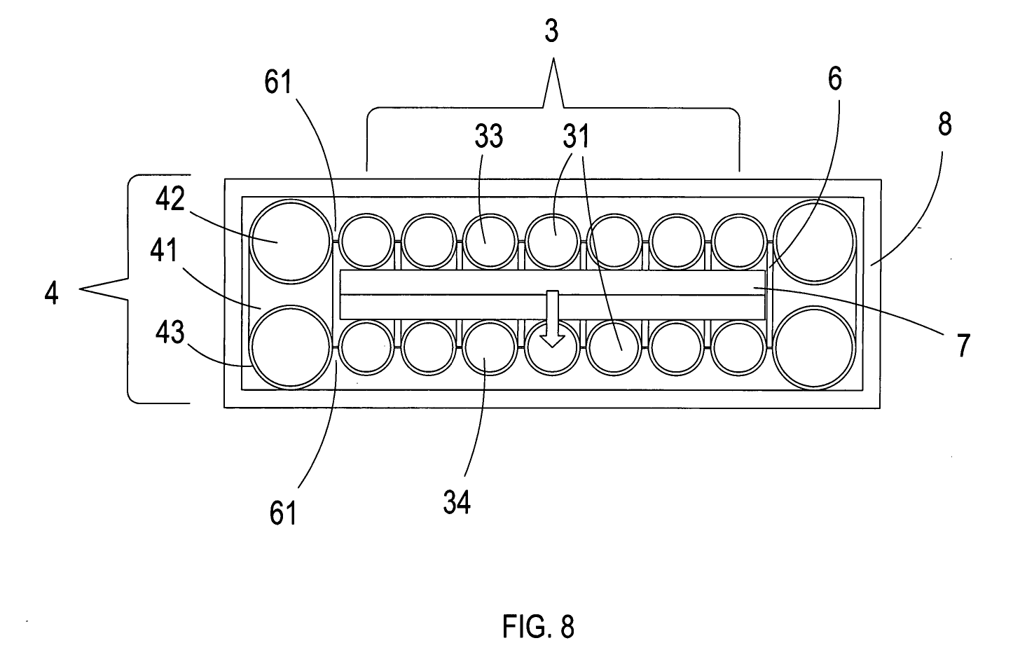

Referring to FIGS. 6, 7, and 8, the perspective and cross-sectional views illustrating how the air cushioning wrapping bag wraps an electronic device is described. The upper and lower main sections 33, 34 define their respective first folding unit 22 and second folding unit 23. The peripheral air tube's diameter of the peripheral air tubes strips 4 is larger than that of its respective main air tubes 31. When folding the first folding unit 22, the second folding unit 23, and their respective peripheral air tubes strips 4, a containing space 6 for housing a product such as an electronic device and an air cushioning layer 61 surrounding the containing space 6 for protection are formed. The folding of the two units 22, 23 and their respective peripheral air tubes sections 42, 43 is operated via a connecting unit 21 and its respective connecting peripheral sections 41. The connecting unit 21 is between the first folding unit 22 and the second folding unit 23. And the connecting peripheral sections 41 are between the upper sections 42 and the lower peripheral sections 43. The folding points 35 arrangement on the connecting unit 21 and the connecting peripheral sections 41 allows the folding of the first folding unit 22, the second folding unit 23, and their respective peripheral air tubes strips 4. The peripheral air tubes on the edges of the electronic device 7 holds and then firmly fastens the device 7 in a manner that the mobility of the device 7 is unlikely occurred. The device 7 is therefore in a secure position. Since the electronic device 7 is fastened in a secure position leaving no more space for possible collision between the peripheral air tubes 4 and the electronic device 7, the damages to the device 7 is preventable. Furthermore, when the wrapping bag 2 which has wrapped the electronic device 7 is put into a box 8, the peripheral air tubes are against the inner walls of the box 8 shown in FIG. 8. And with the multiple main air tubes 31 and the peripheral air tubes as air cushioning layer, the inevitable damages by collision due to improper handlings or during the shipment to the wrapped product may effectively prevent.

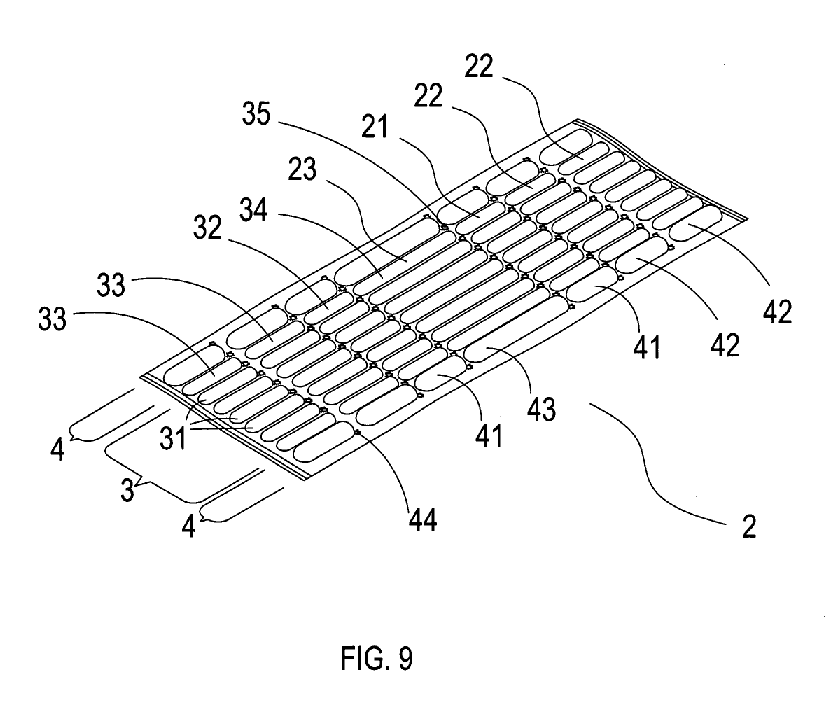

FIG. 9 depicts a perspective view of another embodiment of the invention. An air cushioning wrapping bag 2 includes a strip of main air tubes 3 and a pair of peripheral air tubes strips 4. The main air tubes strip 3 includes multiple main air tubes 31 structured in a row arrangement that each main tube 31 is separate from and parallel to each other. The strip of main air tubes 31 is divided into seven sections, four upper main sections 33, a lower main section 34, and two connecting main section 32. The lower main section 34 which disposes in the middle of the main air tubes trip 3 with its both sides perpendicular to the main air tubes 31 connects with the connecting main sections 32. And the other sides of the connecting sections 32, which are not connected with the lower main section 34, connect with two upper main sections 33. These two upper main sections 33 are arranged by connecting one to the other in sequence. The number of the upper main sections 33 may be added or reduced as the size or shape of products demanded varies. Then, two peripheral air tubes strips 4 connect with two sides of main air tubes strip 3. Each of the peripheral tubes strip 4 includes a lower peripheral section 43, two connecting peripheral section 41 connecting with two ends of the lower peripheral section 43, and two upper peripheral sections 42 that is arranged in sequence connecting with the other end of the connecting peripheral section 41. These peripheral sections 41, 42, and 43 are parallel and with equal lengths to their respective main air tubes sections 32, 33, and 34. The connecting folding units 21 connect one side with the first folding units 22 and the other side with the second folding unit 23. The peripheral air tubes of the peripheral air tubes strips 4 contain larger tube diameter than that of all the main air tubes 31. When folding the first folding units 22, the second folding unit 23, and their respective peripheral sections 42, 43, a containing space 6 for which an electronic device may be housed in and an air cushioning layer 61 surrounding the containing space 6 are formed. Multiple folding points 35 are formed on and along each side of all the sections 32, 33, and 34 during the heat-sealing operation.

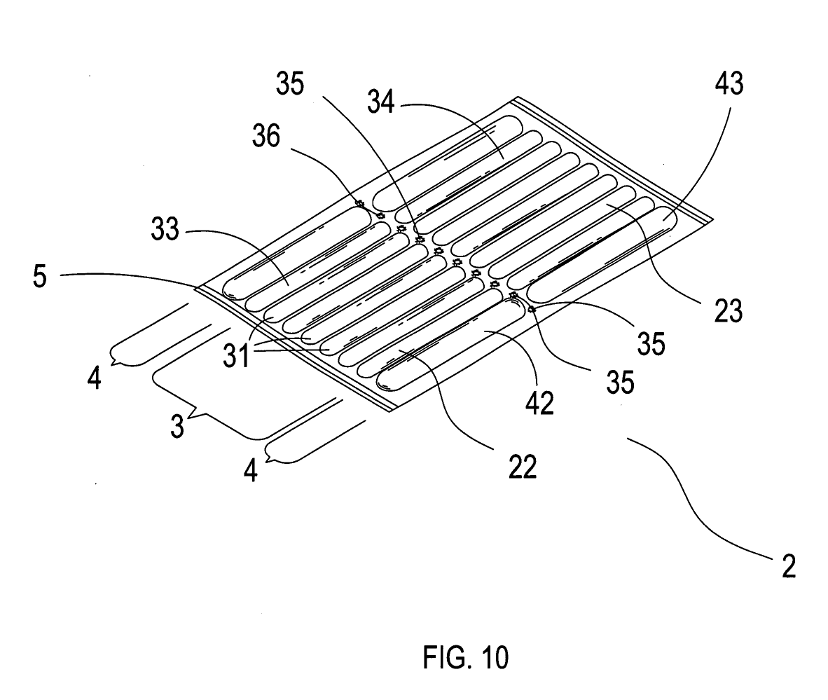

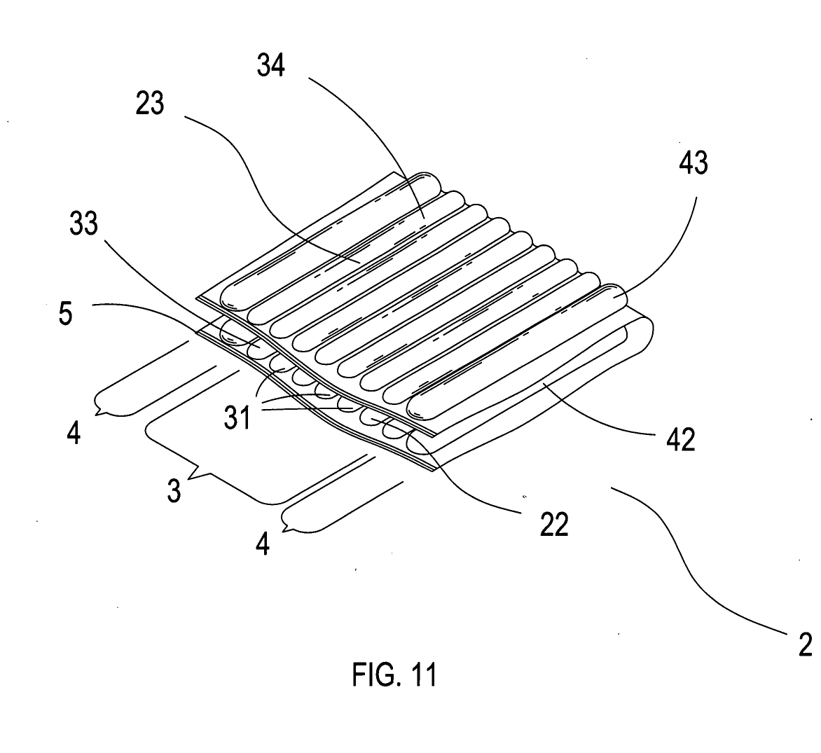

Referring to FIGS. 10, and 11, a modification of the air cushioning wrapping bag is described. A wrapping bag 2 includes a strip of main air tubes 3 and a pair of peripheral air tubes strips 4. The main air tubes strip 3 includes multiple main air tubes 31 structured in a row arrangement. Each of the main air tubes 31 is separate from and parallel to each other. The strip of main air tubes 31 is divided into two sections, the upper main section 33 and the lower main section 34. Multiple folding points 35 are formed during the heat-sealing operation between the two main sections 33, 34. Then, each of the two peripheral air tubes strips 4 respectively connects with both sides of the main air tubes strip 3. Further, each of the peripheral air tubes strips 4 includes an upper peripheral section 42 and a lower peripheral section 43. The upper and lower main sections 33, 34 define their respective first folding unit 22 and second folding unit 23. The folding points 35 arrangement in the middle of the first folding unit 22 and the second folding unit 23 may allow them to fold.

The embodiments of the invention may have various configurations in accordance with different arrangements of settings on the first folding unit, the second folding unit, the connecting unit, and their respective folding points. The strip form design of the invention provides extendibility that may meet and wrap products in any shape and size. The shape of the invention may be varied such as in the shape of L, U, triangle, or polygon. Of course, the other shapes are also possible. Each of the main tubes and peripheral air tubes is separate from each other. Even under certain circumstance, one or more of these air tubes leak, the remainder may still function. The peripheral air tubes on the edges of the electronic device holds and firmly fastens the device in a manner that the mobility of the device is unlikely occurred. The device is therefore in a secure position. Since the electronic device is fastened in a secure position leaving no more space for possible collision between the peripheral air tubes and the electronic device, the damages to the device is preventable. Because the edge of the peripheral air tubes are against the inner walls of the box as well as the multiple main air tubes as air cushioning layer, the inevitable damages due to improper handling during the shipment may effectively prevent. The wrapping bag of the invention may wrap any product or item, especially for those sensitive, sophisticated, and fragile electronic components that require more caring. The invention may be applicable to other products or items requiring similar damages prevention.

Although the invention has been described in terms of exemplary embodiments, it is not limited thereto. Rather, the appended claims should be considered broadly, to include other variants and embodiments of the invention, which may be made by those skilled in the art without departing from the scope and range of equivalents of the invention.

What is claimed is:

1. An air cushioning wrapping bag for wrapping a product, comprising:
a strip of main air tubes comprising a first folding unit, a second folding unit, and a connecting unit, said connecting unit having one side connected with said first folding unit and the opposite side connected with said second folding unit; and
a pair of peripheral air tubes strips connecting with two sides of said main air tubes strip, said peripheral air tube strip having the tube diameter larger than said main air tubes strip's tube diameter, whereby a containing space for housing said product and an air cushioning layer surrounding said containing space are formed when folding said first folding unit, said second folding unit, and their respective said peripheral air tubes strips.

2. The wrapping bag as claimed in claim 1, wherein said main air tubes are arranged in a row, having each of said main air tubes separate from and parallel to each other.

3. The wrapping bag as claimed in claim 1, wherein said main air tubes strip is divided into:
an upper main section, having said main air tubes therein arranged to define said first folding unit;
a lower main section, having said main air tubes therein arranged to define said second folding unit; and
a connecting main section, having said main air tubes therein arranged to define said connecting unit, said connecting main section having one side connected with said upper main section and the opposite side connected with said lower main section.

4. The wrapping bag as claimed in claim 3, wherein said connecting main section includes a plurality of folding points.

5. The wrapping bag as claimed in claim 3, wherein said connecting main section has each of said main air tubes' length shorter than said upper main and said lower main section thereof.

6. The wrapping bag as claimed in claim 1, wherein said peripheral air tube strip comprises:
an upper peripheral section having equal length with said upper main section;
a lower peripheral section, having equal length with said lower main section; and
a connecting peripheral section, having equal length with said connecting section, said connecting peripheral section having one end connected with said upper peripheral section and the opposite end connected with said lower peripheral section.

7. The wrapping bag as claimed in claim 6, wherein said connecting peripheral section includes a plurality of folding points.

8. The wrapping bag as claimed in claim 6, wherein said connecting peripheral section has shorter said peripheral air tube's length than said upper peripheral section and said lower peripheral section thereof.

9. The wrapping bag as claimed in claim 1, wherein said main air tubes strip comprises:
a plurality of upper main sections, connecting with each other in sequence and having said main air tubes therein arranged to define said first folding unit;
a lower main section, having said main air tubes therein arranged to define said second folding unit; and
a pair of connecting main sections disposing on two sides of said lower main section respectively and connecting with thereof, both of said connecting main sections having their opposite sides facing said upper main sections and connecting with thereof, said main air tubes of said connecting main sections arranged to define said connecting unit.

10. The wrapping bag as claimed in claim 9, wherein said connecting main section includes a plurality of folding points.

11. The wrapping bag as claimed in claim 9, wherein said connecting main section has each of said main air tubes' length shorter than said upper main section and lower main sections thereof.

12. The wrapping bag as claimed in claim 9, wherein said upper main section includes a plurality of folding points.

13. The wrapping bag as claimed in claim 1, wherein said peripheral air tube strip comprises:
a plurality of upper sections, having equal length and connecting with their relative said upper main sections;
a lower section, having equal length and connecting with said lower main section; and
a pair of connecting sections, disposing on two ends of said lower section and connecting with thereof, having the other ends of said connecting sections connected with relative said upper sections, containing equal length to their relative said connecting main sections.

14. The wrapping bag as claimed in claim 13, wherein said connecting section includes a plurality of folding points.

15. The wrapping bag as claimed in claim 13, wherein the length of said peripheral air tube of said connecting peripheral section is shorter than said peripheral air tube of said upper and lower regions.

16. The wrapping bag as claimed in claim 13, wherein said upper main sections are connected and arranged in sequence, each of said upper main sections having a plurality of folding points thereon.
